(19) United States
(12) Patent Application Publication
(10) Pub. No.: US 2007/0249512 A1
(43) Pub. Date: Oct. 25, 2007

(54) Solid particulate laundry detergent composition comprising perfume particle

(76) Inventors: Paul R. Mort, Cincinnati, OH (US); Nigel Patrick Somerville Roberts, Newcastle (GB); Christopher Charles Graham, Ellington (GB); Julie Ellis, Newcastle (GB); John Peter Eric Muller, Newcastle (GB)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/788,080

(22) Filed: Apr. 19, 2007

Related U.S. Application Data
(60) Provisional application No. 60/793,352, filed on Apr. 20, 2006.

(51) Int. Cl. C11D 17/00

(52) U.S. Cl. 510/445

(57) ABSTRACT

The present invention relates to a solid particulate laundry detergent composition comprising: (a) from 0.2 wt % to 20 wt % perfume particle; and (b) to 100 wt % of the remainder of the solid particulate laundry detergent composition, wherein the perfume particle comprises from 1 wt % to 60 wt % perfume, wherein the perfume particle has a weight average particle size of from 400 micrometers to 4,000 micrometers, wherein the perfume particle has a bulk density of from 500 g/l to 1,500 g/l, wherein the remainder of the solid particulate laundry detergent composition has a weight average particle size of from 200 micrometers to 1,500 micrometers, and wherein the remainder of the solid particulate laundry detergent composition has a bulk density of from 200 g/l to 1,500 g/l.

### CROSS REFERENCE TO RELATED APPLICATIONS

This application claims priority under 35 U.S.C. §119(e) to U.S. Provisional Application Ser. No. 60/793,352 filed Apr. 20, 2006.

### FIELD OF THE INVENTION

The present invention relates to a solid particulate laundry detergent composition comprising perfume particles.

### BACKGROUND OF THE INVENTION

Detergent manufacturers incorporate perfume into laundry powder products to impart olfactory benefits to the laundered garments. In addition to the conventional perfume incorporation methods of spraying liquid perfume onto the bulk composition, detergent manufacturers have also developed separate perfume particles, such as perfume microcapsules, perfume loaded zeolites and perfume starch encapsulates, that can be dry-added with the remainder of the laundry powder. However, these separate perfume particles are very small and are prone to electrostatic attraction to the walls of containers during their incorporation into the laundry detergent powder, which results in uneven incorporation into the laundry powder.

### SUMMARY OF THE INVENTION

In a first embodiment, the present invention provides a solid particulate laundry detergent composition as defined in Claim 1. In a second embodiment, the present invention relates to a perfume particle as defined in Claim 6. The Inventors have found that perfume particles can be incorporated into solid particulate laundry detergent compositions in an even manner by carefully controlling the physical properties of the perfume particles in relation to the remainder of the solid particulate laundry detergent composition.

### DETAILED DESCRIPTION OF THE INVENTION

### Solid Particulate Laundry Detergent Composition

The solid particulate laundry detergent composition comprises: (a) from 0.2 wt % to 20 wt %, or preferably from 1 wt % and preferably to 10 wt % or even 5 wt % perfume particle; and (b) to 100 wt % of the remainder of the solid particulate laundry detergent composition. The perfume particle and the remainder of the solid particulate laundry detergent composition are described in more detail below.

### Perfume Particle

The perfume particle typically comprises from 1 wt % to 60 wt %, or preferably from 5 wt %, and preferably to 50 wt %, or to 40 wt %, or even to 30 wt % perfume. The perfume may be the reaction product between an amine and an aldehyde or ketone.

The perfume particle typically has a weight average particle size of from 400 micrometers to 4,000 micrometers, or from 500 micrometers, or from 600 micrometers, or from 700 micrometers, or even from 800 micrometers, and preferably to 3,000 micrometers, or to 2,000 micrometers, or even to 1,500 micrometers.

The perfume particle typically has a bulk density of from 500 g/l to 1,500 g/l, or from 600 g/l, or from 700 g/l, or from 800 g/l, and preferably to 1,200 g/l.

The perfume particle preferably has a relative jamming onset (RJO_{bead}) of less than 10.0, or less than 9.0, or less than 8.0, or less than 7.0, or less than 6.0, and preferably from 0.01, or from 0.1 particle.

The perfume particle preferably comprises a core and layer. The core may comprise a perfume and a material selected from sodium carbonate, sodium silicate and/or sodium sulphate. The layer may comprise starch, polymeric carboxylate polymer, and/or a tallow alcohol ethoxylated alcohol having an average degree of ethoxylation of from 50 to 100. The layer may comprise a hydratable material. Suitable hydratable material includes sodium carbonate, preferably in fine particulate form, typically having a weight average particle size of less than 50 micrometers.

The core may comprise sodium carbonate and the layer may comprise perfume in the form of a microcapsule. The perfume in microcapsule form is typically encapsulated by any suitable material. The layer may also comprise sodium carbonate.

The core may comprise sodium carbonate and the layer may comprise perfume and a material selected from sodium carbonate and/or tallow alcohol ethoxylated alcohol having an average degree of ethoxylation of from 50 to 100.

The core may comprise sodium carbonate, polymeric carboxylate polymer and/or zeolite, and the layer may comprise polyethylene glycol and/or sodium carbonate. The layer may also comprise perfume and zeolite; the perfume is typically adsorbed and/or absorbed onto the zeolite. In addition, the core may also comprise perfume.

The perfume particle preferably has a weight average particle size of from 800 micrometers to 1,500 micrometers. The perfume particle preferably has a bulk density of from 800 g/l to 1,200 g/l.

### Remainder of the Solid Particulate Laundry Detergent Composition

The remainder of the solid particulate laundry detergent composition typically has a weight average particle size of from 200 micrometers to 1,500 micrometers. The remainder of the solid particulate laundry detergent composition typically has a bulk density of from 200 g/l to 1,500 g/l. The remainder of the solid particulate laundry detergent composition preferably has a weight average particle size of from 200 micrometers to 700 micrometers. The remainder of the solid particulate laundry detergent composition preferably has a bulk density of from 500 g/l to 700 g/l.

The remainder of the solid particulate laundry detergent composition typically comprises particles that comprise one or more of the following detergent ingredients: detersive surfactants such as anionic detersive surfactants, nonionic detersive surfactants, cationic detersive surfactants, zwitterionic detersive surfactants, amphoteric detersive surfactants; preferred anionic detersive surfactants are linear or branched C₈₋₂₄ alkyl benzene sulphonates, preferably linear C₁₀₋₁₃ alkyl benzene sulphonates, other preferred anionic detersive surfactants are alkoxylated anionic detersive surfactants such as linear or branched, substituted or unsubstituted C₁₂₋₁₈ alkyl alkoxylated sulphate having an average degree of alkoxylation of from 1 to 30, preferably from 1 to 10, more preferably a linear or branched, substituted or unsubstituted C₁₂₋₁₈ alkyl ethoxylated sulphate having an average degree of ethoxylation of from 1 to 10, most preferably a linear unsubstituted C₁₂₋₁₈ alkyl ethoxylated sulphate having an average degree of ethoxylation of from 3 to 7, other preferred anionic detersive surfactants are alkyl sulphates, alkyl sulphonates, alkyl phosphates, alkyl phosphonates, alkyl carboxylates or any mixture thereof; preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; sulphamic acid or salts thereof; citric acid or salts thereof; sources of carbonate, preferably carbonate salts such as sodium carbonate and/or sodium bicarbonate; zeolite builders such as zeolite A and/or zeolite MAP, phosphate builders such as sodium tripolyphosphate; carboxylate polymers such as the co-polymer of maleic acid and acrylic acid; silicate salt such as sodium silicate; and mixtures thereof.

### Relative Jamming Onset (RJO_{bead})

The relative jamming onset is measured using a Flodex™ instrument supplied by Hanson Research Corporation, Chatsworth, Calif., USA. As used in this test method the term “Hopper” refers to the Cylinder Assembly of the Flodex™ instrument; the term “orifice” refers to the hole in the center of the Flow Disk that is used in a flow test; the symbol “B” refers to the diameter of the orifice in the Flow Disk used in the test; and the symbol “b” refers to the dimensionless orifice size, as defined by the ratio of the orifice diameter to the 30^{th} percentile particle size (D₃₀) specified in Applicant's Test Method titled “Flowable Particle Mass Based Cumulative Particle Size Distribution Test”, b=B/D₃₀.

The Flodex™ instrument is operated in accordance with the instructions contained in the Flodex™ operation manual version 21-101-000 rev. C 2004-03 with the following exceptions:

(a) The suitable container that is used to collect the material that is tested is tared on a balance with 0.01 gram precision before the start of the test, and used subsequently to measure the mass of particulate discharge from the Hopper in step (c), below.

(b) Sample preparation. A bulk sample of particles is suitably riffled to provide a sub-sample of 150 ml loose-fill volume. The appropriate sample mass can be determined by measuring the loose fill density specified in the test method titled “bulk density test” described below, and then multiplying by the target volume (150 ml). The mass of the sample (sample mass) is recorded before the start of each test measurement. As the test is non destructive, the same sample may be used repeatedly. The entire sample must be discharged, e.g., by inverting the hopper, and then re-loaded before each measurement.

(c) Starting with the smallest orifice size (typically 4 mm unless a smaller orifice is necessary), three repeat measurements are taken for each orifice size. For each measurement, the sample is loaded into the Hopper and allowed to rest for a rest interval of about 30 seconds before the orifice is opened according to the procedure described in the Flodex™ Operation Manual. The sample is allowed to discharge into the tared container for a period of at least 60 seconds. After this 60 second period and once the flow stops and remains stopped for 30 seconds (i.e., no more than 0.1 mass % of the material is discharged over the 30 second stop interval), then the mass of discharged material is measured, the orifice is closed and the Hopper is fully emptied by inverting the Hopper assembly or removing the flow disk. Note: if the flow stops and then re-starts during the 30 second stop interval, then the stop interval clock must be re-started at zero at the next flow stoppage. For each measurement, the mass % discharged is calculated according to the formula: (mass % discharged)=100 *(mass discharged)/(sample mass). The average of the three mass% discharged measurements is plotted as a function of the dimensionless orifice size (b=B/D₃₀), with the mass % discharged on the ordinate and the dimensionless orifice size on the abscissa. This procedure is repeated using incrementally larger orifice sizes until the hopper discharges without jamming for three consecutive times, as per the description of a “positive result” in the Flodex™ Operation Manual.

(d) The plotted data are then linearly interpolated to find the Relative Jamming Onset (RJO), which is defined as the value of the dimensionless orifice size at the point of 25 mass % average discharge. This is determined by the abscissa value (b) at the point where the interpolation is equal to 25 mass % discharge. If the average mass % discharge exceeds 25% for the starting orifice, then flow disks with smaller orifices must be obtained and the test repeated starting with the smaller orifice. Flow disks with smaller orifices such as 3.5, 3.0, 2.5 or even 2.0 mm can be obtained as custom parts from Hanson Research Corporation.

### EXAMPLES

### Example 1

### Perfume Particle 1

The core material is screened granular sodium carbonate prepared by a classification between 425 micrometer and 710 micrometer screens. The layering powder is also sodium carbonate, milled using a Retsch ZM200 to produce a milled material of <30 micrometers. The liquid binder is tallow alcohol ethoxylated alcohol having an average degree of ethoxylation of 80 (TAE₈₀).

A mass of 200 grams of the core particles is loaded into a Kenwood FP520 Series mixer with a stainless steel bladed impeller and the mixer turned on to speed setting #1 to induce a centrifugal flow pattern in the mixer. 48.9 grams of perfume oil is then added drop-wise via a syringe, contacting the core particles in the mixer. A series of four sequential layering steps are then performed, alternately adding 6.15 grams of liquid binder drop-wise via a syringe, contacting the core particles in the mixer, followed by 50.5 grams of layering powder, also added through the top of the mixer, adding more binder, more layering powder, etc., until the product composition is built up in layers surrounding the core particles. 202 grams of layering powder is added in total. 24.6 grams of liquid binder is added into the mixer in total.

The resulting coated particle is then screened through 1180 micrometers and on 425 micrometers. The particle is free flowing.

### Example 2

### Perfume Particle 2

The core material is screened granular sodium carbonate prepared by a classification between 425 micrometer and 710 micrometer screens. The layering powder is also sodium carbonate, milled using a Retsch ZM200 to produce a milled material of <30 micrometers. The liquid binder is an aqueous solution containing perfume microcapsules, with the following composition:

Liquid Binder 1: perfume oil—36.0 % w/w, miscellaneous wall material—17.9% w/w, water—46.1% w/w.

A mass of 150 grams of the core particles is loaded into a Kenwood FP520 Series mixer with a stainless steel bladed impeller and the mixer turned on to speed setting #1 to induce a centrifugal flow pattern in the mixer. A series of five sequential layering steps are then performed, alternately adding 27 grams of liquid binder drop-wise via a syringe, contacting the core particles in the mixer, followed by 43 grams of layering powder, also added through the top of the mixer, adding more binder, more layering powder, etc., until the product composition is built up in layers surrounding the core particles. 215 grams of layering powder is added in total. 135 grams of liquid binder is added into the mixer in total.

The resulting coated particle is then screened through 1180 micrometers and on 425 micrometers. The particle is free flowing.

### Example 3

### Perfume Particle 3

The core material is screened granular sodium carbonate prepared by a classification between 425 micrometer and 710 micrometer screens. The layering powder is also sodium carbonate, milled using a Retsch ZM200 to produce a milled material of <30 micrometers. The liquid binder is a hot melt solution containing perfume, with the following composition:

Liquid Binder 2: perfume oil—24.0% w/w, polyethyleneimine—16.1% w/w, tallow alcohol ethoxylated alcohol having an average degree of ethoxylation of 80—59.9% w/w.

A mass of 200 grams of the core particles is loaded into a Kenwood FP520 Series mixer with a stainless steel bladed impeller and the mixer turned on to speed setting #1 to induce a centrifugal flow pattern in the mixer. A series of five sequential layering steps are then performed, alternately adding 20 grams of liquid binder drop-wise via a syringe, contacting the core particles in the mixer, followed by 32 grams of layering powder, also added through the top of the mixer, adding more binder, more layering powder, etc., until the product composition is built up in layers surrounding the core particles. 160 grams of layering powder is added in total. 100 grams of liquid binder is added into the mixer in total.

The resulting coated particle is then screened through 1180 micrometers and on 425 micrometers. The particle is free flowing.

### Example 4

### Perfume Particle 4

The core material, agglomerate core material 1, is screened agglomerate of composition detailed below, prepared by a classification between 425 micrometer and 710 micrometer screens. The layering powders are a milled version of the same agglomerate core material 1, milled using a Retsch ZM200 to produce a milled material of <30 micrometers and layering powder 1, a perfume loaded sodium aluminosilicate, zeolite structure material. The liquid binder is a polyethylene glycol having a molecular weight of 4,000 Da (PEG₄₀₀₀) solution at 60° C.

Agglomerate core material 1: sodium carbonate—40.4% w/w, sodium aluminosilicate, zeolite structure—36.7% w/w, sodium acrylic-maleic copolymer—16.2% w/w, miscellaneous materials and water—6.7% w/w.

Layering powder 1: sodium aluminosilicate, zeolite structure—83% w/w, perfume oil—17% w/w.

A mass of 150 grams of the core particles are loaded into a Kenwood FP520 Series mixer with a stainless steel bladed impeller and the mixer turned on to speed setting #1 to induce a centrifugal flow pattern in the mixer. 33.8 grams of Perfume oil is then added drop-wise via a syringe, contacting the core particles in the mixer. A layering step is performed, adding 10 grams of 60° C. PEG₄₀₀₀ drop-wise via a syringe, contacting the perfume wetted core particles. This is followed by a 29 gram dose of layering powder 1. A series of three sequential layering steps are then performed, alternately adding 10 grams of 60° C. PEG₄₀₀₀ drop-wise via a syringe, contacting the core particles in the mixer, followed by 38 grams of the milled agglomerate core material 1, the product composition is built up in layers surrounding the core particles. 114 grams of milled agglomerate core material 1 is added in total as layering powder. 40 grams of PEG₄₀₀₀ is added into the mixer in total as liquid binder.

The resulting coated particle is then screened through 1180 micrometers and on 425 micrometers. The particle is free flowing.

### Example 5

### Finished Product Formulations Incorporating Above Perfume Particle Examples

TABLE 1
Finished Product formulations (% w/w)

| Ingredient* | (a) | (b) | (c) | (d) | (e) | (f) | (g) |
|---|---|---|---|---|---|---|---|
| 1 | 1.7 | 0.0 | 4.0 | 0.0 | 4.0 | 2.3 | 0.0 |
| 2 | 0.0 | 0.0 | 0.2 | 0.2 | 0.0 | 0.3 | 0.3 |
| 3 | 0.0 | 3.2 | 0.0 | 3.6 | 0.0 | 0.0 | 4.4 |
| 4 | 0.4 | 0.0 | 0.2 | 0.0 | 0.0 | 0.5 | 0.0 |
| 5 | 20.0 | 20.0 | 23.0 | 23.0 | 13.5 | 22.3 | 22.3 |
| 6 | 37.0 | 35.9 | 26.5 | 25.9 | 6.4 | 28.5 | 26.9 |
| 7 | 0.0 | 0.0 | 0.0 | 0.0 | 0.3 | 0.0 | 0.0 |
| 8 | 7.5 | 7.5 | 8.5 | 8.5 | 13.0 | 10.5 | 10.5 |
| 9 | 1.0 | 1.0 | 0.0 | 0.0 | 0.0 | 0.0 | 0.0 |
| 10 | 0.0 | 0.0 | 4.0 | 4.0 | 0.0 | 0.0 | 0.0 |
| 11 | 1.0 | 1.0 | 3.8 | 3.8 | 0.0 | 1.5 | 1.5 |
| 12 | 0.9 | 0.9 | 0.0 | 0.0 | 0.7 | 0.5 | 0.5 |
| 13 | 0.0 | 0.0 | 0.5 | 0.5 | 5.5 | 1.0 | 1.0 |
| 14 | 0.2 | 0.2 | 0.2 | 0.2 | 0.2 | 0.1 | 0.1 |
| 15 | 0.0 | 0.0 | 0.0 | 0.0 | 1.8 | 0.0 | 0.0 |
| 16 | 15.4 | 15.4 | 2.0 | 2.0 | 20.1 | 9.0 | 9.0 |
| 17 | 0.2 | 0.2 | 0.2 | 0.2 | 0.1 | 0.1 | 0.1 |
| 18 | 0.4 | 0.4 | 0.5 | 0.5 | 0.1 | 0.4 | 0.4 |
| 19 | 0.2 | 0.2 | 1.0 | 1.0 | 0.2 | 0.4 | 0.4 |
| 20 | 0.5 | 0.5 | 0.0 | 0.0 | 0.6 | 0.0 | 0.0 |
| 21 | 1.5 | 1.5 | 3.0 | 3.0 | 2.0 | 1.4 | 1.4 |
| 22 | 7.3 | 7.3 | 15.6 | 15.6 | 16.7 | 7.2 | 7.2 |
| 23 | 0.3 | 0.3 | 0.5 | 0.5 | 1.0 | 0.3 | 0.3 |
| 24 | 0.4 | 0.4 | 0.5 | 0.5 | 0.4 | 0.2 | 0.2 |
| 25 | 1.1 | 1.1 | 3.4 | 3.4 | 5.5 | 0.9 | 0.9 |
| 26 | 0.2 | 0.2 | 0.1 | 0.1 | 0.2 | 0.2 | 0.2 |
| 27 | 0.0 | 0.0 | 0.0 | 0.0 | 1.0 | 0.1 | 0.1 |
| 28 | 0.0 | 0.0 | 0.0 | 0.0 | 0.3 | 0.0 | 0.0 |
| 29 | 0.0 | 0.0 | 0.0 | 0.0 | 0.0 | 8.5 | 8.5 |
| 30 | 0.0 | 0.0 | 0.0 | 0.0 | 0.0 | 0.2 | 0.2 |
| 31 | 0.0 | 0.0 | 0.0 | 0.0 | 0.0 | 0.9 | 0.9 |
| 32 | 2.8 | 2.8 | 2.3 | 2.3 | 6.4 | 2.7 | 2.7 |

*Table 1 ingredient list: 1) Any perfume particle example 1–2 detailed above; 2) Perfume particle example 3 detailed above; 3) Perfume particle example 4 detailed above; 4) perfume oil, spray-on; 5) sodium carbonate; 6) sodium sulphate; 7) sodium silicate; 8) sodium alkyl benzene sulfonate; 9) tallow alkyl sulfate; 10) sodium alkyl ethoxysulfate; 11) sodium acrylic-maleic copolymer; 12) cationic detersive surfactant; 13) non-ionic detersive surfactant; 14) optical brightener; 15) carboxymethyl cellulose; 16) sodium aluminosilicate, zeolite structure; 17) ethylenediamine disuccinic acid; 18) MgSO₄; 19) hydroxyethane di(methylene phosphonic acid); 20) Soap; 21) citric acid; 22) sodium percarbonate (having from 12% to 15% active AvOx); 23) enzymes; 24) suds suppressor agglomerate (11.5% active); 25) TAED agglomerate (92% Active TAED, 5% carboxymethyl cellulose); 26) photobleach particle (1% active); 27) hydrophobically modified cellulose; 28) soil release polymer; 29) bentonite clay; 30) polyethylene oxide flocculating agent; 31) silicone oil; 32) moisture and raw material by products.

All documents cited in the detailed description of the invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid particulate laundry detergent composition comprising:
(a) from 0.2 wt % to 20 wt % perfume particle; and
(b) to 100 wt % of the remainder of the solid particulate laundry detergent composition, wherein the perfume particle comprises from 1 wt % to 60 wt % perfume, wherein the perfume particle has a weight average particle size of from 400 micrometers to 4,000 micrometers, wherein the perfume particle has a bulk density of from 500 g/l to 1,500 g/l, wherein the remainder of the solid particulate laundry detergent composition has a weight average particle size of from 200 micrometers to 1,500 micrometers, and wherein the remainder of the solid particulate laundry detergent composition has a bulk density of from 200 g/l to 1,500 g/l.

2. A solid particulate laundry detergent composition according to claim 1, wherein the perfume particle has a relative jamming onset (RJO_{bead}) of less than 10.0.

3. A composition according to claim 1, wherein the perfume particle comprises a core and layer, wherein the core comprises a perfume and a material selected from sodium carbonate, sodium silicate, sodium sulphate, wherein the layer comprises starch, polymeric carboxylate polymer, and/or a tallow alcohol ethoxylated alcohol having an average degree of ethoxylation of from 50 to 100, wherein the layer comprises a hydratable material.

4. A composition according to claim 3, wherein the hydratable material is sodium carbonate in fine particulate form having a weight average particle size of less than 50 micrometers.

5. A composition according to claim 1, wherein the perfume particle comprises a core and layer, wherein the core comprises sodium carbonate, the layer comprises perfume in the form of a microcapsule, and wherein the layer comprises sodium carbonate.

6. A composition according to claim 1, wherein the perfume particle comprises a core and layer, wherein the core comprises sodium carbonate, the layer comprises perfume, and wherein the layer comprises sodium carbonate and/or tallow alcohol ethoxylated alcohol having an average degree of ethoxylation of from 50 to 100.

7. A composition according to claim 6, wherein the perfume is the reaction product between an amine and an aldehyde or ketone.

8. A composition according to claim 1, wherein the perfume particle comprises a core and layer, wherein the core comprises sodium carbonate, polymeric carboxylate polymer and/or zeolite, the layer comprises polyethylene glycol and/or sodium carbonate, wherein the layer comprises perfume and zeolite, wherein the perfume is adsorbed and/or absorbed onto the zeolite.

9. A composition according to claim 8, wherein the core comprises perfume.

10. A composition according to claim 1, wherein the perfume particle has a weight average particle size of from 800 micrometers to 1,500 micrometers, wherein the perfume particle has a bulk density of from 800 g/l to 1,200 g/l, wherein the remainder of the solid particulate laundry detergent composition has a weight average particle size of from 200 micrometers to 700 micrometers, and wherein the remainder of the solid particulate laundry detergent composition has a bulk density of from 500 g/l to 700 g/l.
